(19) United States
(12) Patent Application Publication
(10) Pub. No.: US 2022/0017292 A1
(43) Pub. Date: Jan. 20, 2022

(54) PACK FOR PREPARING FOOD OR BEVERAGE PRODUCTS, USE THEREOF AND METHOD THEREWITH

(71) Applicant: SOCIETE DES PRODUITS NESTLE S.A., Vevey (CH)

(72) Inventors: Carlo Magri, Monthey (CH); Amaud Gerbaulet, Oye et Pallet (FR)

(21) Appl. No.: 17/293,605

(22) PCT Filed: Oct. 7, 2019
(86) PCT No.: PCT/EP2019/077018

§ 371 Date: May 13, 2021

(30) Foreign Application Priority Data
Nov. 14, 2018 (EP) 18206203.4

(51) Int. Cl. B65D 85/804; B65D 75/58; A47J 31/40

(52) U.S. Cl. CPC B65D 85/8043; B65D 2575/583; A47J 31/407; B65D 75/5877

(57) ABSTRACT

The invention relates to a pack (100) for the preparation of a food or beverage product comprising an insert (10) and a container (20), the container (20) being configured by at least one sheet folded in such a way to configure a container where the ingredients for the food or beverage product are stored, the water to extract and/or infuse and/or dissolve and/or reconstitute the ingredients in the container (20) and to prepare the food or beverage product being introduced through the insert (10), the food or beverage product once prepared being also dispensed through this insert (10), the pack (100) presenting a generally plane shape and being essentially vertically oriented during food or beverage production with the insert (10) arranged at the lower side of the pack (100) so the water is supplied into the volume of the container in an upward direction; such that the insert (10) is a part that is arranged connected externally to the container (20). Typically, the insert (10) is a part that is arranged externally and connected to the container (20), the insert (10) is tightly sealed and/or glued to the container (20). The invention further relates to the use of a pack (100) as the one described for preparing a food or beverage product and further relates to a method for preparing a food or beverage product using such a pack (100).

### FIELD OF THE INVENTION

The present invention relates to a pack for preparing food or beverage products: in particular, the pack comprises a flexible container where a food or beverage product is comprised and an insert that can move and adopt multiple orientations or positioning within the container. The invention further relates to a method for preparing a food or beverage product from such a pack.

### BACKGROUND OF THE INVENTION

Preparing beverages by introducing a capsule containing a food or beverage ingredient, such as ground coffee or instant coffee, in a beverage dispensing machine and injecting water into the capsule is known in the state of the art: the beverage or food ingredient is typically extracted or dissolved into water to form the beverage or the desired final product, which flows out of the capsule through a suitable outlet.

As such, different capsules have been developed in the past, these capsules being at least differentiated by the nature of the capsule body used for storing the food or the beverage ingredient. While most of the capsules are made of a rigid body or semi-rigid body, typically made through injection moulding or thermoforming, flexible types of packs can be made out of foil materials. Flexible packs have generally the advantage to semi-rigid and rigid capsules that less amount of material is used to pack the product which leads to overall less production cost, to lower life cycle impact shown in several life-cycle assessments and to advantages on the part of the user, who will need less available space for storing these packs, as they are more compact.

It is known in the state of the art, for example as per document WO 99/05044, a flexible beverage-producing sachet comprising a beverage ingredient in a volume formed by bonding two laminates at their edges, having a base seam into which a conduit of rigid plastics is bonded. An inlet nozzle is provided at the top of the resulting sachet for introducing water that is mixed with the beverage or food ingredient inside the inner volume of the sachet, the beverage produced being then evacuated through a beverage outlet arranged at the bottom of the pack, where closing means are provided, such that the closing means are adapted to open under pressure when pressurized water is introduced into the sachet, allowing the beverage to evacuate through the beverage outlet. However, this configuration presents important drawbacks for the consumer: the opening of the closing means is obtained by increase of pressure inside the sachet. Yet this pressure increase is not recommended for the preparation of some beverages because it creates bubbles at the surface of the beverage, for example this would not be desired for the preparation of tea. Besides, there exists the risk for the user that the packages may not rupture at the desired pressure, and that they would finally open up in an uncontrollable explosion. For this reason the apparatus where the sachet is processed needs to comprise means for totally enclosing the sachet in the machine during beverage preparation in order to avoid damages for the consumer. Such flexible beverage-producing sachets as described do not therefore allow a proper control of the insertion of water in the inner volume, and neither a proper control of the outlet for delivering the beverage prepared inside. Therefore, it would be desirable to have a flexible sachet that allows this specific and good regulated control of the inlet and of the outlet parts.

Another drawback of these known sachets is that the inlet nozzle introduces water in the pack always according to the same vertical top-down orientation in the sachet. Therefore, all the beverages are produced according to the same process inside the sachet. Yet depending on the nature of the beverage ingredient and the desired beverage the beverage ingredient should be processed differently. It would thus also be very advantageous to provide a sachet where the inlet of the fluid and the outlet of the prepared beverages are differently configured according to the type of product or beverage that is prepared inside.

Other problems of existing pouches in the state of the art are for example that, when having a powder ingredient in its inner volume that is diluted or processed in order to prepare an appropriate beverage, sometimes powder starts to be dispensed without the product having been properly prepared or diluted: avoiding this would also be a main advantage of a sachet or pouch.

Another disadvantage of existing pouches or sachets is that, when the food product or beverage has been prepared and the sachet is removed from the machine, in most of the cases, because the outlet through which the product is dispensed still remains open, dripping of the remaining product inside occurs.

Therefore, it would be desirable to provide a flexible pack for preparing food or beverage products which addresses the problems and drawbacks in the state of the art.

It is known also in the state of the art, and belonging to the same applicant, the patent application number WO 18033431 A1, disclosing a pack with an insert or fitment assembly comprising two parts which are relatively moveable with respect to each other such as to control the communication of the opening and/or closing of the inner volume of the pack with the outside, so dispensing can start only once the beverage is correctly prepared; dripping at the end of the process is avoided by closing the communication of the pack with the outside and different steps in the preparation and/or dispensing process can be controlled.

Therefore, it is an object of the present invention to provide an improved solution to certain functionalities to the pack of WO 18033431 A1 of the applicant, as it will be further explained. The invention aims at these and other objectives and particularly at the solution of other problems as will appear in the rest of the present description.

### SUMMARY OF THE INVENTION

According to a first aspect, the invention relates to a pack for the preparation of a food or beverage product comprising an insert and a container, the container being configured by at least one sheet folded in such a way to configure a container where the ingredients for the food or beverage product are stored, the water to extract and/or infuse and/or dissolve and/or reconstitute the ingredients in the container and to prepare the food or beverage product being introduced through the insert, the food or beverage product once prepared being also dispensed through this insert, the pack presenting a generally plane shape and being essentially vertically oriented during food or beverage production with the insert arranged at the lower side of the pack so the water is supplied into the volume of the container in an upward direction. The insert in the pack of the invention is a part that is arranged connected externally to the container.

Preferably, in the pack of the invention, the insert is a part that is arranged externally and connected to the container. The insert can be tightly sealed and/or glued to the container.

Typically, the insert in the pack of the invention comprises three relatively moveable elements:
an injection inlet for opening an inlet communication with the inside of the container and inject water inside the volume of it;
a primary element to be arranged fixed to a beverage extraction machine;
a secondary element relatively moveable with respect to the primary element, allowing opening an exit communication from the inner volume of the container and allowing the dispensing of the prepared beverage from the container to the outside of the pack.

Preferably, the injection inlet and the primary element in the pack of the invention are integrally formed.

In the pack according to the present invention, the injection inlet is typically joined by flexible arms to the primary element allowing the displacement of the injection inlet with respect to the primary element.

Preferably, the insert is configured such that an injection inlet for opening an inlet communication with the inside of the container and inject water inside the volume of it is connectable to the said insert.

In the pack of the invention, the injection inlet preferably comprises a water inlet and an air inlet communicating with the inner volume of the container. Typically, the air is suctioned from the outside of the pack by the water flow inside the volume of the container created by the injection of water through the water inlet.

Typically, the insert comprises displacing holes arranged in the secondary element to linearly displace it according to certain path.

According to a preferred embodiment of the invention, the insert of the pack is configured such that it can be reversibly accessed by a beverage preparation machine.

Typically, in the pack according to the invention, the insert and/or the container comprise identification means with the information on the process parameters for the preparation of the food or beverage product. The process parameters typically comprise one or a plurality of the following: total volume of water to introduce, the temperature of the water, the time of preparation, the pressure at which the water is introduced.

In another preferred embodiment of the pack of the invention, the insert is detachable from the container for recycling.

According to a second aspect, the invention further relates to the use of a pack as the one described for preparing a food or beverage product.

Yet according to a third aspect, the invention relates to a method for preparing a food or beverage product using a pack as the one described. The method according to the invention comprises the steps of:
introducing the pack in a beverage preparation machine essentially vertically and with the insert on the lower side of it;
the insert is connected by a preparation machine which displaces the secondary element linearly upwards with respect to the primary element in order to open an inner outlet aperture in the container while the secondary element blocks the exit of the volume of the container,
the injection inlet is moved to open a communication with the inside volume of the container to inject water inside of it;
the two steps previously described take place in reverse order;
the position is maintained for a certain time as needed, to achieve the dissolution of the food or beverage product inside the container, and then the secondary element is displaced downwards with respect to the primary element, so the inner outlet aperture is no longer blocked and the food or beverage product can be delivered through a dispensing outlet;
the secondary element moves linearly upwards with respect to the primary element, so the inner outlet aperture is blocked and no product can exit the container.

### BRIEF DESCRIPTION OF THE DRAWINGS

Further features, advantages and objects of the present invention will become apparent for a skilled person when reading the following detailed description of non-limiting embodiments of the present invention, when taken in conjunction with the appended drawings, in which:

FIG. 1 shows a general overview of a pack for preparing food or beverage products according to the present invention.

FIG. 2 shows a detailed view of the insert or fitment in a pack for preparing food or beverage products according to the present invention.

FIGS. 3a and 3b show a frontal and a cut side view, respectively, of the insert or fitment in a pack for preparing food or beverage products according to the present invention.

FIG. 4 shows in detail the insert or fitment in a pack for preparing food or beverage products according to the present invention, in a first open position, where the secondary relatively moveable element of the insert has pierced the inner volume of the pack.

FIG. 5 shows in detail the insert or fitment in a pack for preparing food or beverage products according to the present invention, in a second open position, where the injection inlet or piston element of the insert has pierced the inner volume of the pack.

FIG. 6 shows a frontal view in detail of the insert in the pack for preparing food or beverage products according to the present invention, showing the position where water and/or air are introduced in the inner volume of the pack.

FIG. 7 shows a frontal view of the insert in the pack for preparing food or beverage products according to the present invention where the product is being dispensed.

FIG. 8 shows a frontal view of the insert in the pack for preparing food or beverage products according to the present invention where the moveable elements of the insert have moved to a position allowing extraction of the pack from a machine, avoiding dripping.

FIG. 9 shows in detail the insert or fitment in a pack for preparing food or beverage products according to the present invention, in a first open position according to a second possible sequencing, where the injection inlet has pierced the inner volume of the pack.

### DETAILED DESCRIPTION OF EXEMPLARY EMBODIMENTS

According to a first aspect, the invention relates to a pack 100 for preparing food or beverage products. The pack 100 comprises an insert 10 and at least one food or beverage container 20: this container 20 comprises at least one ingredient for the preparation of the food or beverage product. When more than one container is used (not represented in the Figures), typically each container comprises a different product or ingredient such that they are mixed in order to obtain a more complex product or beverage recipe preparation. The content of the containers can then be either sequentially or simultaneously prepared and dispensed through the insert 10. In the Figures attached to this Description and in what follows in the rest of it, only the preferred embodiment of one container 20 is shown, though. Typically, the container 20 is a flexible container, referred to as pouch or sachet, though any kind of container which is made for example more rigid, is also possible and is comprised in the object of the invention.

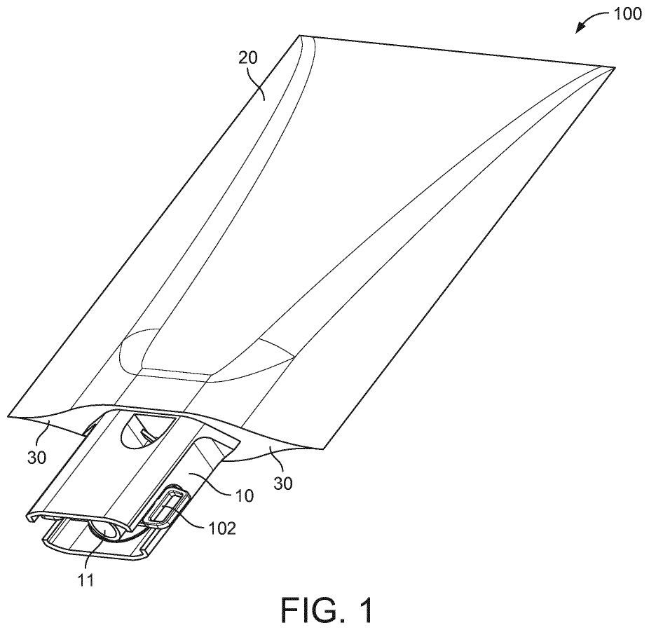

The insert 10 is joined to the pouch or sachet preferably in the lower and external part of it, as represented in FIG. 1: the container 20 comprises a product, typically a powder, which will be mixed and/or reconstituted and/or diluted to produce a food or beverage product, typically by the addition of a fluid, preferably water, through the insert 10. The fluid (water) will be introduced in the volume of the container 20 via the insert 10 and the food or beverage product prepared will also be delivered via this insert 10, as it will be further explained in detail in what follows. The insert 10 of the pack of the invention can move and adopt multiple orientations or positioning within the container, for different steps of the preparation and/or delivery of the food or beverage product.

According to the present invention the food or beverage ingredient of the container can be comprised within the list of: soups, fruit juices, vegetable juices, bouillons, coffee, chocolate, tea, milk or creamer, smoothies, purees, coulis, creams or a combination thereof. The food or beverage ingredient can be a soluble food or beverage ingredient. Preferably the food or beverage ingredient is a soluble food or beverage ingredient selected in the list of:
instant coffee powder, milk powder, cream powder, instant tea powder, cocoa powder, soup powder, fruit powder or mixture of said powders,
a coffee concentrate, a milk concentrate, a syrup, a fruit or vegetable concentrate, a tea concentrate, a fruit or vegetable puree.

The powders can be agglomerated or sintered. The powders or liquid concentrates can be mixed with solid pieces for example for preparing soups with solid pieces. The food or beverage ingredient can also be an infusable food or beverage ingredient like a roast and ground coffee or tea leaves. In that embodiment water extracts the infusable ingredient.

In the present invention fluid covers any aqueous diluent that can be mixed with a soluble beverage ingredient to prepare a beverage, like water, carbonated water, milk, etc. However, according to the invention, water is the preferred fluid which will be used.

FIG. 1 attached shows a general view of the pack 100 of the invention, comprising an insert 10 and a container 20: this container 20 is typically configured with at least one flexible sheet folded to obtain a closed container (it can be however configured differently, with a more rigid structure but still configuring the said container). The insert 10 is joined to this container 20 on the lower side of it, preferably being sealed or glued to it, onto a flexible sheet side 30 that will be pierced for introducing the water in order to prepare the food or beverage product; this sheet side 30 will also be pierced for opening the exit required for the dispensing of the food or beverage product via a dispensing outlet 11.

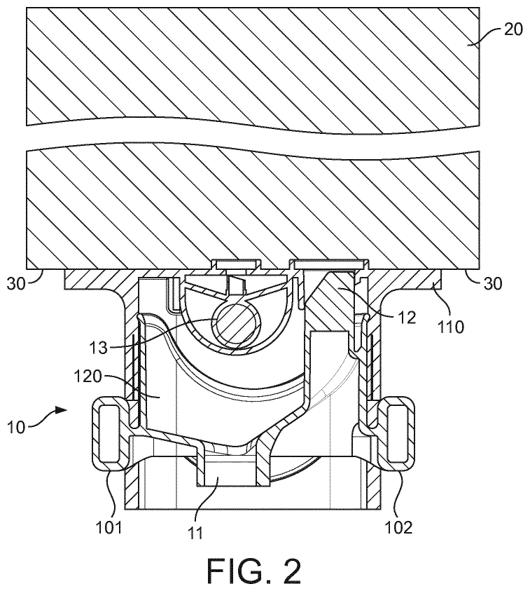

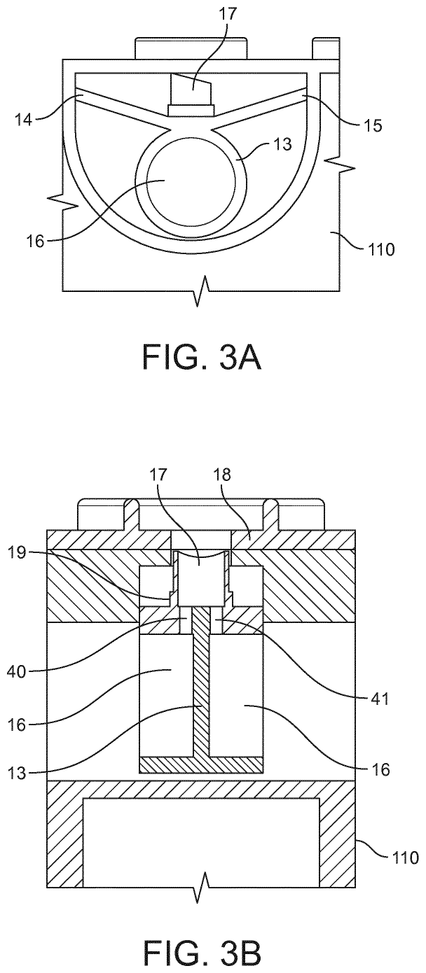

Looking at FIG. 2, further details of the insert 10 are shown. This insert 10 comprises three relatively moveable elements 110, 120 and 13, as it will be explained. The elements 110 and 13 are integrally formed. The relative movement of these three elements 110, 120 and 13 allows the insert 10 to adopt different positioning with respect to the container for the different steps of the preparation and/or delivery of the food or beverage product, allowing a direct flow extraction of the food or beverage product. The insert 10 comprises a primary element 100 that is fixed to the beverage preparation machine while the food or beverage product is prepared: typically, the pack of the invention is positioned by means of the insert 10 in the machine. The insert further comprises a secondary element 120, which is moveable with respect to the primary element 110, typically by linear displacement (vertical). The injection inlet or piston element 13 is integrally formed with the primary element 110: this injection inlet 13 is also displaceable with respect to the primary element 110, by the movement of flexible inlet arms 14 and 15 (see FIG. 3a): the piston or injection inlet 13 is joined to the primary element 110 by means of inlet arms 14 and 15, which are flexible, and allow that the injection inlet 13 moves up and pierces the corresponding film part 30. The secondary element 120 connects with the food or beverage preparation machine by means of displacing holes 101 and 102: the machine can then displace the secondary element 120 with respect to the primary element 110 (not moving), typically vertically: when the movement of the element 120 is vertically upwards, an inner outlet 12 will pierce the film 30 and will then allow product to exit the inner volume of the container 20 via this inner outlet 12 and then through a dispensing outlet 11.

The pack 100 of the invention is arranged and maintained in place in the food or beverage preparation machine by means of positioning holes or pins (not shown) arranged in the insert. Also, another possibility would be to tightly hold the insert 10 in place in the machine by holding means.

Looking at FIG. 3a, the injection inlet element 13 (or piston) is joined to the primary element 110 by flexible arms 14 and 15 allowing the displacement upwards of the inlet 13 and so a piercing inlet 17 of it will pierce the corresponding area of the flexible sheet 30. Injecting means from the food or beverage preparation machine (typically a needle) will connect the injection inlet 13 through an injection chamber 16: these means will move the inlet 13 upwards so the piercing inlet 17 will pierce and open the flexible sheet 30 allowing injection of water inside the volume of the container 20 for the food or beverage product preparation: the movement upwards of this piston element 13 is possible thanks to the flexible arms 14 and 15. FIG. 3b shows a cut view of the piston element 13 shown in FIG. 3a: the injection inlet 13 moves vertically upwards through an injection inlet housing 18, and is arranged at an injection inlet support 19. Once the injection means of the machine connect the injection inlet 13 in the injection chamber 16 (or inlet cavities 16) and the piercing inlet 17 pierces and opens the corresponding part of the sheet 30, water is injected through the injecting means at pressure and enter the inner volume of the container through a water inlet 41. At the same time, air is allowed inside this volume through an air inlet or air suction conduit 40: the addition of air allows the foaming of the food or beverage product.

Typically, the injection chamber 16 can be reversibly accessed, either frontally or through the rear side of the insert 10. This allows a further advantage in the use of the pack of the invention, as the consumer does not need to think how to place the pack in the machines, as it will work in any of the orientations of it.

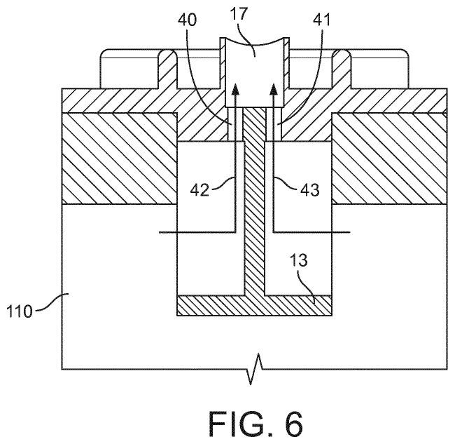

Also, tight tolerances between the injection inlet housing 18 and the injection inlet support 19 ensure tightness in the injection chamber 16 and in the injection inlet 13 (or piston element). When the injection inlet 13 (or piston) and the corresponding piercing inlet 17 are in the upper position, therefore having pierced the flexible sheet 30 allowing the injection of water in the container 20, (according to FIG. 6), there is no gap between the injection inlet housing 18 and the injection inlet support 19, so tightness is ensured between the container 20 and the insert 10 when you inject water through the piston element 13 when the piston has pierced the film and is in the upper or injection position. Like that all water that you inject goes into the inner volume of the container for the dissolution and cannot exit around the piston element 13.

It is also possible, according to another embodiment of the invention, to configure the injection inlet 13 (or piston element) as an external part or element to the insert 10 that will be connectable to it: typically, it will be part of the beverage machine and will connect the insert 10 once the pack will be in use for preparing the food or beverage product from it. Preferably, in this case, there will be no arms 14, 15 with the inlet 13 as it will be not any longer joined to the primary element 110.

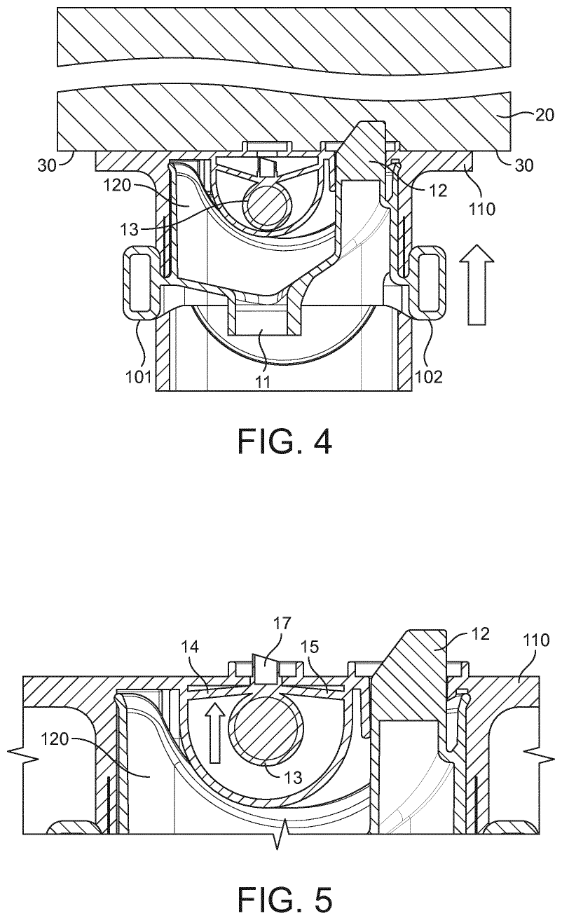

In FIG. 4, it is shown the position of the secondary element 120 when it has displaced vertically upwards with respect to the primary element 110: the inner outlet 12 has pierced in this displacement the film 30 found during its movement. The displacing holes 101, 102 where the machine connects the secondary element 120, allow the displacement upwards of this element 120 with respect to the primary element 110. This is the first step of the beverage or food product preparation: the secondary element 120 has displaced upwards, so the inner outlet 12 has pierced the film 30.

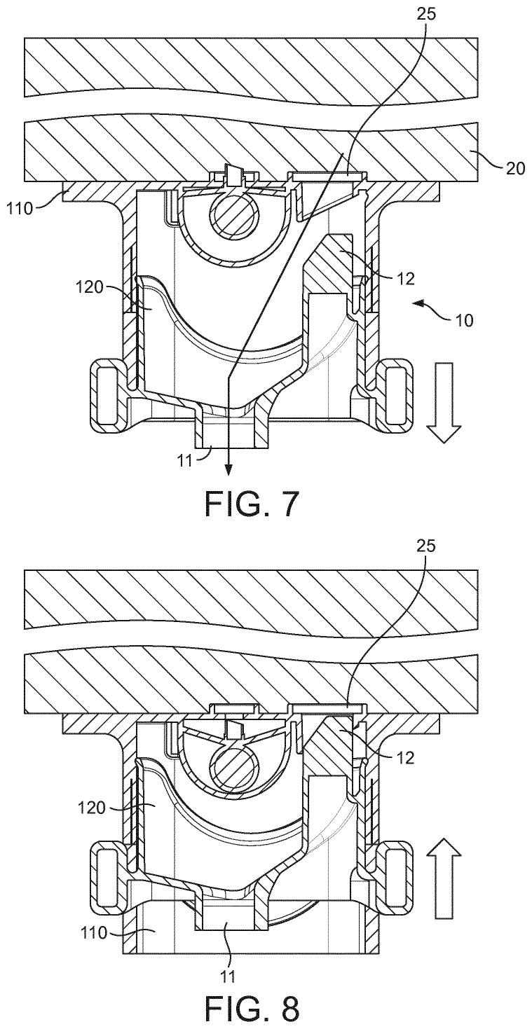

A second step in the beverage or food product preparation is represented in FIG. 5: after the position of the secondary element 120 with respect to the primary element 110 shown in FIG. 4, the injection inlet or piston element 13 moves upwards thanks to the flexible inlet arms 14, 15 displacing also upwards, as represented in FIG. 5, so the piercing inlet 17 pierces the corresponding area of the flexible sheet 30, allowing the positioning as shown in FIG. 6 where an air flow 42 and a water flow 43 enter the inner volume of the container. While water and air are introduced in the inner volume of the container 20 in order to prepare the food or beverage product inside, the inner outlet 12 of the secondary element 120 is blocking the exit of any beverage through this element 120 and into the dispensing outlet 11 (an inner outlet aperture 25 in the primary element 110 is blocked by the inner outlet 12, as shown in FIG. 5): this position stays during the required time for the dissolution to be prepared. Once the food or beverage product has been correctly prepared (the dissolution and/or reconstitution of powder has been properly achieved), the secondary element 120 displaces vertically downwards with respect to the primary element 110 and the inner outlet 12 no longer blocks the inner outlet aperture 25, so the food or beverage product prepared can be delivered through this aperture 25 and into the dispensing outlet 11 to the outside of the pack, preferably into a cup (see FIG. 7): this direct dispensing into cup avoids hygiene problems and makes the process highly advantageous.

The next step in the food or beverage product preparation is represented in FIG. 8: the secondary element 120 displaces once again upwards, vertically, via the displacement holes 101, 102, until the inner outlet aperture 25 is blocked by the inner outlet 12. Therefore, there is no communication of the inside of the volume of the container 20 with the outside: this position is used at the end of the process, when the beverage or food product has been delivered, so the pack 100 can be removed from the machine without any risk of dripping.

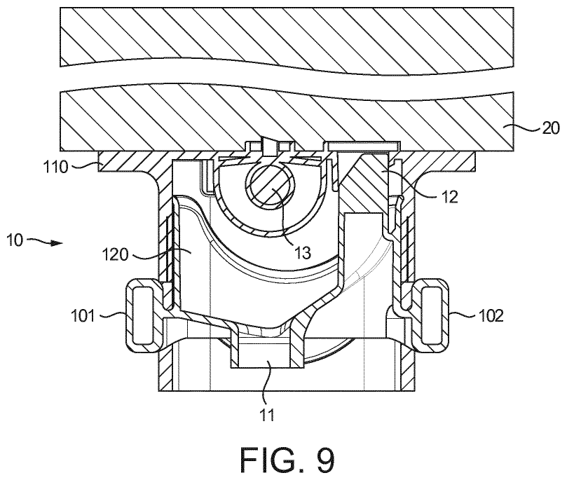

As it has been described, the first step in a food or beverage preparation process will be the one shown in FIG. 4: the secondary element 120 has first moved upwards and the inner outlet 12 has pierced the film of the container around the inner outlet aperture 25. In the position represented in FIG. 4, the injection inlet 13 has not yet moved and has not pierced the film of the container. In a second step, as shown in FIG. 5, this injection inlet 13 moves upwards and pierces the film and starts injecting fluid (water) into the volume of the container. There is also another possibility for carrying out the process or method of the invention: a first step would be to move the piston or injection inlet upwards, so that the film of the container is pierced and the water can be injected inside the container's volume, as it is represented in FIG. 9. A second step would be then to move upwards the secondary element 120 so the inner outlet 12 pierces the film over the inner outlet aperture 25, as it is represented in FIG. 5. This position will be maintained during the preparation of the food or beverage product and, when it is ready, the secondary element 120 will move downwards as in FIG. 7 allowing the dispensing of the product through the dispensing outlet 11. Finally, to avoid dripping, when the pack 100 will be removed from the machine, the position will come again to that shown in FIG. 9, where the inner outlet 12 blocks the exit from the inner volume of the container (and the injection inlet or piston 13 is moved up still).

The pack of the present invention, as it has been described in detail, comes to solve several problems present in the different solutions of the state of the art: the pouch or pack tightness needs to be improved, opening and reclosing of the insert has to be provided, air suction is desirable and water injection through the insert with no leakage is also a must.

The solutions in the state of the art with wrapped inserts comprise several interfaces which create potential points of air entry, with the consequent risk of shortening the product shelf life. Solutions with external inserts are difficult to be reclosed in a clean and hygienic way during extraction. If a direct injection in a flexible pack or container is envisaged via a needle, this needle has to be provided with a small water inlet into the pouch in order to obtain the required waterjet inside it: however, clogging may occur in this small water inlet orifice, something that is avoided with the solution proposed by the invention. Also, the pack of the invention presents an easy solution providing direct air suction in the pack while tightness is ensured at the same time.

In the solution of the present invention, an insert 10 is externally attached (by gluing or sealing) onto a flexible container 20: this external insert 10 comprises all the necessary functions to allow a clean and direct flow extraction of the product inside the pack:
water injection interface with the machine;
air inlet allowing air suction;
product dispensing outlet;
moveable part in the insert allowing opening and reclosing of the insert outlet to achieve extraction sequencing;
the particularity of having the injection inlet housing with a moveable injection inlet (or piston) that always stays attached on the housing;
the particularity of keeping the air inlet integrated with the water injection;
by attaching the external insert 10 to the flexible container 20 (by gluing or sealing), both the container 10 and the insert 10 can be made flexible, in material and in shape, allowing solutions with a high flexibility.

Further advantages of the pack configuration according to the present invention are the following:
the speed of manufacturing the pack with the external insert being glued or sealed is higher than in other solutions where the insert is, for example, overwrapped in the film configuring the container;
the insert configuration is less expensive than in other solutions, like for example the overwrapped insert one, as the interface with the machine is simpler;
the insert is smaller, more compact than in other solutions so requires less material and is therefore less costly;
it is easier to separate the insert element from the rest of the container than in other solutions in the state of the art, for example for a further recycling of it or the like;
the overall tightness of the pack is simpler and is improved with respect to other known solutions;
as the insert is an external part to the container, it is easier to correctly place the pack in a food or beverage preparation machine, as the pack is positioned in the machine through this insert piece.

The insert 10 is preferably rigid and is made of a rigid plastic material, preferably by injection moulding. Typically, this plastic material can be selected from the following: polypropylene, polyethylene, polyethylene terephthalate and polylactic acid. Also according to a less preferred embodiment the insert 10 can be made of a metal like aluminium or tin-plate. However, at least the inlet arms 14 and 15 are made of a flexible material and so configured to allow the movement upwards and/or downwards of the injection inlet 13 (or piston element).

Preferably, fluid is injected at a pressure higher than 2 bars, more preferably higher than 3 bars, preferably comprised between 2 and 10 bars, more preferably of around 7 bars through the injection inlet 13 (injection chamber 16). Then, via the water inlet 41, with a diameter much lower than the section in the injection chamber 16, the fluid is converted into a jet of fluid with a velocity typically of at least 20 m/s, preferably of at least 30 m/s.

As described, the injection chamber 16 and the water inlet 41 are configured for introducing the fluid under the form of a jet in the inner volume of the container 20. By jet it is understood a stream of liquid or fluid that comes out of the fluid inlet and into the inner volume of the food or beverage container quickly and with force.

The food or beverage container 20 configuring the pack 100 preferably comprises two flexible water impermeable sheets joined to one another to define an inner volume where at least one ingredient is stored. Other materials which are more rigid and which end up configuring a sachet or pouch similar to the one described are also possible and comprised within the scope of the present invention. Preferably, the food or beverage container presents an essentially plane shape, wherein the insert 10 is arranged on one of the sides of the pack 100. Preferably the pack itself is substantially flexible and looks like a pouch or sachet. The flexible sheet material can be plastic laminates, metallised foil or alufoil or fibre base material. According to the invention the two flexible water impermeable sheets can be formed of one single flexible water impermeable sheet folded in half and joined at its free edges.

The pack 100 can also comprise an excrescence enabling the handling of the pack by the user or consumer: this has not been shown in the Figures attached, though.

Typically, the two flexible water impermeable sheets joined to one another to define the inner volume of the container are formed of one single flexible water impermeable sheet folded in half and joined at its free edges. According to said mode the container is a plane pouch made of a flexible material sheet, said sheet being folded at the top of the container and bonded on its edges to define the inner volume, the bottom bonded edge typically including the insert 10. This embodiment constitutes a particularly easy way to manufacture the pack 100 comprising the container and the insert since it requires the cutting of only one piece of sheet—most preferably according to a rectangular shape—and its folding to create the inner volume for the food or beverage ingredient. Typically, also for manufacturing convenience, the insert 10 is introduced in the bottom edge of the container during the sealing of its edges.

According to the invention, the pack 100 is provided with identification means (either in the insert 10 and/or on the food or beverage container 20), these identification means comprising the information for the processing of the ingredients inside the container 20 and providing this information to appropriate control means in the food or beverage preparation machine. As already mentioned, this information can comprise for example the parameters in the preparation process, such as: temperature of the fluid introduced, flow and total volume of the fluid, preparation time, sequences of relative movement of the moveable elements 110, 120, 13 in the insert 10, etc.

These identification means can comprise any kind of recognition means such as, for example, mechanical codes, optical codes, RFID tags, bar codes, magnetic codes, or the like. These identification means could also be made as detection holes arranged for example on one lateral edge of the food or beverage container, configured by the two flexible sheets brought together to conform the pouch or container, preferably on the sealing area of the container, where there is no product or ingredient. When the two sheets are brought together and are welded on the edges to configure a container, on one of these lateral edges, additional welding with circumferential shape will be provided, thus configuring the holes as punching holes. A plurality of holes will typically be provided vertically on one of the edges of the container brought together: these holes will allow light to pass through and, depending on the configuration of the holes, the machine will be provided with the information for the processing of the container that has to be followed. Because the packs 100 according to the present invention are made reversible, in order to allow the machine read the identification means independently on the sense in which the pack 100 has been introduced, these identification means, typically these detection holes or punched holes, will be provided on two lateral edges of the container. The identification means can also provide the machine with the information regarding the sense of introduction of the pack.

Preferably, according to the invention, the pack 100 presents a plane shape oriented along a plane essentially vertically oriented during beverage production and the fluid inlet orientates the jet of fluid in a direction comprised in said plane. The fluid jet introduced from the bottom into the container is developing into circular and spiral movements creating turbulences, frictions and high contact surfaces between the fluid molecules (typically, water molecules) and the ingredient particles. In average the fluid molecules have several turns within the container until they leave it together with the beverage or food product once mixed. Best results (reconstitution) have been observed with a pack of rectangular shape.

According to the invention, the food or beverage container is arranged essentially vertically during the production and dispensing of the product or beverage, and the insert 10 is arranged in such a way that the fluid coming through the piercing inlet 17 is supplied into the container 20 in an upward direction.

Preferably, in the pack 100 according to the present invention, the insert 10 is detachable from the container 20 in an easy way, allowing recycling of the components of the container 20 and the insert 10 in case they are made of different materials, for example.

According to another aspect, the invention refers to a method for preparing a food or beverage product from a pack 100 and using a food or beverage preparation machine. The method of the invention comprises the following steps:
a) the pack 100 is introduced in a food or beverage machine, placing the insert 10 in the corresponding receptacle arranged and shaped to receive it, so the pack is disposed essentially vertically in the machine, with the insert 10 on the lower side of it;
b) the machine connects the insert 10 in the displacing holes 101, 102 and displaces the secondary element 120 linearly upwards with respect to the primary element 110, so the part of the film 30 around the inner outlet aperture 25 is pierced by the displacement of the inner outlet 12, to a position where this inner outlet 12 blocks the exit of any content in the volume of the container 20 through this inner outlet aperture 25 (position of FIG. 4);
c) the machine connects the injecting means (typically a needle) through the injection chamber 16 in the injection inlet 13 and moves the piercing inlet 17 linearly upwards, so piercing the part of the film 30 over it: once this is done, the injecting means start injecting a fluid (water) at pressure through this chamber 16, through the water inlet 41 and into the volume of the container, as a water jet, also injecting a flow of air through the air inlet 40 (position of FIG. 5);
d) the position in the previous step (position of FIG. 5) is maintained for a certain time as needed, so the dissolution of the food or beverage product inside the container is properly achieved (typically, the identification means in the pack will provide the information on the time needed for this, that depends on the type of food or beverage product being prepared): once the food or beverage product has been properly prepared, the machine moves linearly downwards the secondary element 120 with respect to the primary element 110, so the inner outlet aperture 25 is no longer blocked by the inner outlet 12, so the food or beverage product can be delivered through the dispensing outlet 11 (FIG. 7);
e) after this step, the machine moves once again the secondary element 120 linearly upwards with respect to the primary element 110, so the inner outlet aperture 25 is once again closed by the inner outlet 12, so no product can exit the container 20 (FIG. 8): this position is used at the end of the process, when the pack 100 is extracted from the machine, thus avoiding any dripping out of it.

The steps in the method of the invention can also be carried out differently:
a) the pack 100 is introduced in a food or beverage machine, placing the insert 10 in the corresponding receptacle arranged and shaped to receive it, so the pack is disposed essentially vertically in the machine, with the insert 10 on the lower side of it;
b) the machine connects the injecting means (typically a needle) through the injection chamber 16 in the injection inlet 13 and moves the piercing inlet 17 linearly upwards, so piercing the part of the film 30 over it: once this is done, the injecting means start injecting a fluid (water) at pressure through this chamber 16, through the water inlet 41 and into the volume of the container, as a water jet, also injecting a flow of air through the air inlet 40 (position of FIG. 9);
c) the machine connects the insert 10 in the displacing holes 101, 102 and displaces the secondary element 120 linearly upwards with respect to the primary element 110, so the part of the film 30 around the inner outlet aperture 25 is pierced by the displacement of the inner outlet 12, to a position where this inner outlet 12 blocks the exit of any content in the volume of the container 20 through this inner outlet aperture 25 (position of FIG. 5);
d) the position in the previous step (position of FIG. 5) is maintained for a certain time as needed, so the dissolution of the food or beverage product inside the container is properly achieved (typically, the identification means in the pack will provide the information on the time needed for this, that depends on the type of food or beverage product being prepared): once the food or beverage product has been properly prepared, the machine moves linearly downwards the secondary element 120 with respect to the primary element 110, so the inner outlet aperture 25 is no longer blocked by the inner outlet 12, so the food or beverage product can be delivered through the dispensing outlet 11 (FIG. 7);
e) after this step, the machine moves once again the secondary element 120 linearly upwards with respect to the primary element 110, so the inner outlet aperture 25 is once again closed by the inner outlet 12, so no product can exit the container 20 (FIG. 5): this position is used at the end of the process, when the pack 100 is extracted from the machine, thus avoiding any dripping out of it.

Although the present invention has been described with reference to preferred embodiments thereof, many modifications and alternations may be made by a person having ordinary skill in the art without departing from the scope of this invention which is defined by the appended claims.

1. Pack for the preparation of a food or beverage product comprising an insert and a container:
the container being configured by at least one sheet folded in such a way to configure a container where the ingredients for the food or beverage product are stored,
the water to extract and/or infuse and/or dissolve and/or reconstitute the ingredients in the container and to prepare the food or beverage product being introduced through the insert, the food or beverage product once prepared being also dispensed through this insert:
the pack presenting a generally plane shape and being essentially vertically oriented during food or beverage production with the insert arranged at the lower side of the pack so the water is supplied into the volume of the container in an upward direction; and
the insert is a part that is arranged connected externally to the container.

2. Pack according to claim 1 wherein the insert is a part that is arranged externally and connected to the container.

3. Pack according to claim 2 wherein the insert is tightly sealed and/or glued to the container.

4. Pack according to claim 1 wherein the insert comprises three relatively moveable elements:
an injection inlet for opening an inlet communication with the inside of the container and inject water inside the volume of it;
a primary element to be arranged fixed to a beverage extraction machine; and
a secondary element relatively moveable with respect to the primary element, allowing opening an exit communication from the inner volume of the container and allowing the dispensing of the prepared beverage from the container to the outside of the pack.

5. Pack according to claim 4 wherein the injection inlet and the primary element are integrally formed.

6. Pack according to claim 5 wherein the injection inlet is joined by flexible arms to the primary element allowing the displacement of the injection inlet with respect to the primary element.

7. Pack according to claim 1 wherein the insert is configured such that an injection inlet for opening an inlet communication with the inside of the container and inject water inside the volume of it is connectable to the insert.

8. Pack according to claim 4 wherein the injection inlet comprises a water inlet and an air inlet communicating with the inner volume of the container.

9. Pack according to claim 8 wherein the air is suctioned from the outside of the pack by the water flow inside the volume of the container created by the injection of water through the water inlet.

10. Pack according to claim 1 wherein the insert comprises displacing holes arranged in the secondary element to linearly displace it according to certain path.

11. Pack according to claim 1 wherein the insert is configured such that it can be reversibly accessed by a beverage preparation machine.

12. Pack for the preparation of a food or beverage product according to claim 1 wherein the insert and/or the container comprise identification means with the information on the process parameters for the preparation of the food or beverage product.

13. Pack for the preparation of a food or beverage product according to claim 12 wherein the process parameters comprise one or a plurality of the following: total volume of water to introduce, the temperature of the water, the time of preparation, the pressure at which the water is introduced.

14. Pack for the preparation of a food or beverage product according to claim 1 wherein the insert is detachable from the container for recycling.

15. (canceled)

16. Method for preparing a food or beverage product using a pack comprising an insert and a container, the container being configured by at least one sheet folded in such a way to configure a container where the ingredients for the food or beverage product are stored, the water to extract and/or infuse and/or dissolve and/or reconstitute the ingredients in the container and to prepare the food or beverage product being introduced through the insert, the food or beverage product once prepared being also dispensed through this insert: the pack presenting a generally plane shape and being essentially vertically oriented during food or beverage production with the insert arranged at the lower side of the pack so the water is supplied into the volume of the container in an upward direction; and the insert is a part that is arranged connected externally to the container, the method comprising the steps of:
introducing the pack in a beverage preparation machine essentially vertically and with the insert on the lower side of it;
the insert is connected by a preparation machine which displaces the secondary element linearly upwards with respect to the primary element in order to open an inner outlet aperture in the container while the secondary element blocks the exit of the volume of the container;
the injection inlet is moved to open a communication with the inside volume of the container to inject water inside of it;
the two steps previously described take place in reverse order;
the position is maintained for a certain time as needed, to achieve the dissolution of the food or beverage product inside the container, and then the secondary element is displaced downwards with respect to the primary element, so the inner outlet aperture is no longer blocked and the food or beverage product can be delivered through a dispensing outlet; and
the secondary element moves linearly upwards with respect to the primary element, so the inner outlet aperture is blocked and no product can exit the container.
